(19) United States
(12) Patent Application Publication
(10) Pub. No.: US 2012/0105282 A1
(43) Pub. Date: May 3, 2012

(54) Method And Apparatus For Determination Of The Positioning Of An Apparatus Or An User From Satellite Signaling

(76) Inventor: Risto Juhani Mononen, Espoo (FI)

(21) Appl. No.: 13/318,903

(22) PCT Filed: May 4, 2009
(86) PCT No.: PCT/EP2009/003183

§ 371 Date: Jan. 9, 2012

(51) Int. Cl. G01S 19/42

(52) U.S. Cl. 342/357.25

(57) ABSTRACT

Method and apparatus for the calculation of the positioning from satellite signals, wherein the results of a first satellite signal (M1) and a second satellite signal are used for the said calculation, the receiver of the satellite signals is fixed located during the time period between receiving the first satellite signal and the second satellite signal, wherein the first satellite signal is received from a first satellite, and the second satellite signal is received from the same said first satellite being different positioned.

### TECHNICAL FIELD OF THE INVENTION

The present invention relates to the determination of the positioning of an apparatus based on received satellite signaling and post processed trilateration methods, particularly to a method, a network apparatus, a device and a computer readable medium for calculation the positioning of the said apparatus.

### BACKGROUND OF THE INVENTION

Legacy location determination of an apparatus via GPS satellite signals may be performed via GPS receiver and a post processed 3D (three dimensional) trilateration method.

The Global Positioning System (GPS) is a space based radio-navigation system. The system consists of satellites and their signals, control stations monitoring and maintaining the satellites, GPS receivers which are capable of recording the satellite signals and user devices using observation techniques and calculation methods designed to achieve certain level of accuracy. The system is only useable in locations with a clear, unobstructed view of the sky. This restricts the use of GPS in urban areas and for in-house or underground usage.

The basic positioning concept comprises satellites which orbits the Earth and continuously transmits signals. The position of the satellite is transmitted as part of the satellite signal. The distance from the receiver to the satellite is measured by the receiver of the user. The receiver position can be uniquely determinate by the intersection of the three spheres with radii equal to the measured distances to at least three satellites.

The GPS system can only function well if the information where the satellites are positioned and the GPS time of their clocks are exactly given. This information is emitted every 12.5 minutes from the satellites and is called Almanac data. The Almanac data can also be downloaded from a server of the IP network instead.

The GPS receiver has a highly accurate clock and is able to match its own clock to GPS time. This is needed to determine the time difference between the satellite and the GPS receiver.

The GPS receiver determines its position by being able to calculate its distance from several simulataneously observed satellites. Distances are observed to satellites by providing measurements which are derived from a binary code modulated on the carriers, or from the carrier phase measurement derived from the carrier signal itself. The positioning itself is calculated via the trilateration method. Trilateration is a method for determining the intersections of three sphere surfaces given the centers and radii of the three spheres.

GPS measurements may be effected by errors addressing spatial correlation of the satellite, faulty timing corrections, delayed transmitted signal, or excessive measurement noise at the GPS receiver.

This invention is addressing the problem of the determination the positioning of an apparatus in networks supporting femtocells. A femtocell is a small cellular base station, typically designed for use in residential or small business environments. It allows service providers to extend service coverage indoors. The concept is applicable to all standards, including GSM, CDMA2000, TD-SCDMA and WiMAX solutions.

WiMAX, meaning Worldwide Interoperability for Microwave Access, is a telecommunications technology that provides for the wireless transmission of data using a plurality of transmission modes, from point-to-point links to portable internet access. The technology is based on the IEEE 802.16 standards.

Mobile WiMAX System standard is being standardized in WiMAX Forum. The Forum uses the broadband radio interface standardized by IEEE. The Forum specifies standard for network system architecture for mobile & portable terminals to access the Internet and operator services. Currently, a revision of the radio standard, IEEE 802.16-2009, issues.

WiMAX Forum requires that the network shall be able to determine the WiMAX Femto Access Point location with sufficient accuracy before activation of its transmitter and anytime when the link between the network and WFAP is active.

3GPP LTE (Long Term Evolution) is the name to a project within the Third Generation Partnership Project to cope with future technology evolutions.

The determination the location of a femtocell may be needed since the femtocell nodes may be transported to any location and attached to the network.

The emergency calls require location accuracy of 50 meters in the US.

In the outdoor environment GPS can easily provide the required femtocell node location accuracy. Indoors the GPS satellite signal attenuates in the outer walls, and typically the signal is not available simultaneously from four GPS satellites as required for the location detection. Consequently the legacy possitining determination via GPS can not provide the location in the general case.

GPS and user entered street address are the commonly proposed solutions to the femtocell information. Lack of GPS signal indoors and the unreliability of the user entered data are the key disadvantages.

The task of this invention may to provide positioning of an apparatus located indoor where the legacy GPS method can not be provided.

### SUMMARY OF THE INVENTION

According to an exemplary embodiment of the present invention a network apparatus, a device, a method and a computer readable medium is provided for the determination of the location of an apparatus from satellite signaling.

The term “network apparatus” may comprise any apparatus, which may comprise of a locally fixed installed apparatus or a mobile apparatus and may comprise several devices. A device may be provided with software and hardware which empower the device for its operating. A device may be e.g. a receiver such as a GPS receiver being part of a node of a telecommunication network. A node may be an access node, a server, a Home Node B gateway, or a mobile node. An access node may be a base station, a femtocell, a WiMAX Femto Access Point, a Home Node B, an access point, a node B, or an evolved Node B. A mobile station, also named as subscriber station or terminal may be a mobile device like a mobile phone, PDA (Personal Digital Assistant), Internet Tablet, Laptop, CPE (Customer Premises Equipment) unit, modem or similar type of device.

This invention may be applied to the femto technology fields. The femto technology may be part of WiFi and WiMAX network technology, 3GPP LTE (Long Term Evolution) network technology, UTRAN or GSM network technology and future network technology beyond the mentioned ones.

According to an exemplary embodiment of the present invention the calculation of the positioning of an apparatus or an user from satellite signals may use the results of at least a first satellite signal and a second satellite signal, wherein the said first satellite signal may be received from a first satellite, and the said second satellite signal need not be received simultaneously with the said first satellite signal.

The second satellite signal need not be received at the moment when the first signal is received. This may happen when the second satellite is not visible when the first signal is received or when the second signal is received from the same satellite at different time instant. In the latter case the satellite has to be different positioned in order being suitable for the determination of the receiver's positioning.

The calculation of the positioning may need at least three measurements received from satellite signals. A fourth one may compensate timing errors.

According to a further exemplary embodiment the calculation of the positioning may be based on a trilateration algorithm.

According to a further exemplary embodiment the receiver of the satellite signal may be fixed located during the time period between receiving the first satellite signal and the second satellite signal.

The legacy determination of the positioning from satellite signals requires four satellites visibility simultaneously, wherein the determination of the positioning is commonly calculated according a 3D trilateration algorithm. A femto base station, equipped with means of a GPS receiver may be located stationary at home and thus it may record the distance from one satellite, may wait for another one to become visible, and may calculate the location from four consecutive measurements, instead of the simultaneous ones that are needed with moving receivers. It may be possible to wait for a single satellite to move between the four measurements that become the input for the 3D trilateration.

The indoor GPS clock of the present invention may use a processing gain of greater than 13 dB for acquiring and tracking low level GPS signals for providing a highly accurate GPS-based frequency. In a base coherent embodiment, the indoor GPS clock may use GPS data bit length (20 millisecond) coherent integrations for acquisition and tracking of low level GPS signals. In an extended coherent embodiment the indoor GPS clock may use coherent integration periods longer than the GPS bit data for acquisition of low level GPS signals. In a coherent-incoherent embodiment, the indoor GPS clock incoherently combines coherent integration periods for acquisition of low level GPS signals. The low level GPS signals are then tracked with carrier-less tracking using GPS data bit length coherent integration periods. A clock bias feedback loop may provide feedback for disciplining frequency and time signals. A holdover driver may compensate for drift in the disciplined frequency and time signals for at least several hours in the absence of the GPS signal.

An advantage of the present invention is that an accurate GPS-based frequency is provided within a building where GPS signal levels are lower than about −143 dBm.

According to a further exemplary embodiment the said receiver is a GPS receiver. The GPS receiver may be integrated at a femtocell node.

According to a further exemplary embodiment the trilateration algorithm may be a 3D trilateration algorithm using the signals received by the GPS receiver.

According to a exemplary embodiment an apparatus may have means adapted for calculation of the positioning from satellite signals, may be arranged for receiving a first satellite signal used for the said calculation from a first satellite, and may be arranged for receiving a second satellite signal which can not be received simultaneously with the first signal. This may happen when a second satellite is not visible when the first signal is received or when the second signal is received from the same satellite. In the latter case the satellite has to be different positioned in order to the results of the satellite signaling being suitable for the determination of the receiver's positioning.

According to a further exemplary embodiment the apparatus may be arranged for calculation of the positioning based on trilateration algorithm.

According to a exemplary embodiment the second satellite signal used for the calculation, may be received from the same satellite after it has moved into a different position.

The said apparatus may be fixed located during the time period between receiving the first satellite signal and the second satellite signal.

According to a further exemplary embodiment may be a GPS receiver and may be part of a femtocell node.

According to a further exemplary embodiment the almanac data may be acquired via the internet. This includes ephemeris data acquisition as well as GPS clock information.

According to a further exemplary embodiment the almanac data comprising of ephemeris data and GPS clock information, are acquired from the satellites.

According to a further exemplary embodiment the femtocell node may synchronize to the WiMAX macro base station signals or other WiMAX nodes to improve its position determination.

According to a exemplary embodiment a computer program may calculate the positioning of an apparatus or an user wherein the calculation is based on a received first satellite signal from a first satellite, and based on a received second satellite signal which are not received simultaneously with the first satellite signal.

The GPS receiver at the femtocell node may use the trilateration algorithm such that the earlier measurements are used as inputs for the calculation. Satellites or other components in the positioning system do not have to be changed.

### DETAILED DESCRIPTION

To further clarify the objects, technical schemes and advantages of the present invention, the present invention is further described in detail with reference to the accompanying drawings and embodiments. It needs to be pointed out that the embodiments described here are merely for the purposes of illustrating the present invention; they are not to be understood as limiting the present invention.

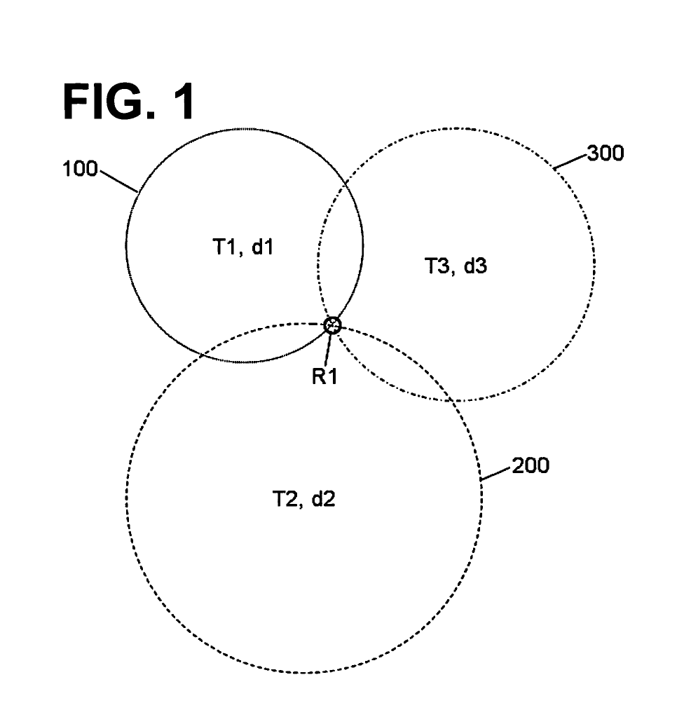

FIG. 1 shows an exemplary embodiment of the present invention, wherein three satellite signals are measured at different time and distances.

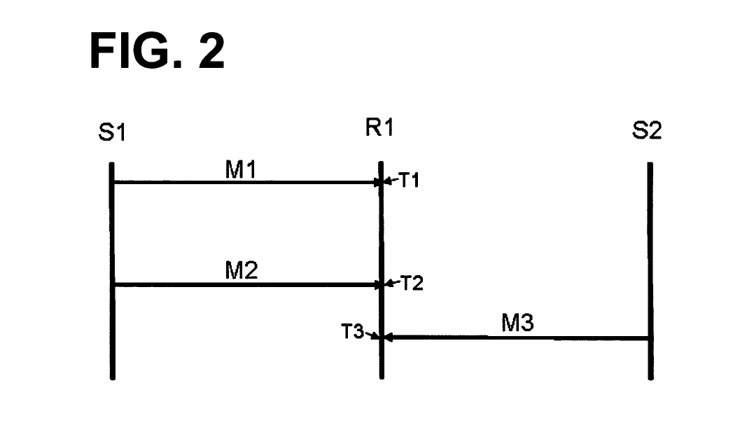

FIG. 2 shows a flow diagram of the present invention, wherein the signals of the satellite are received at different moments.

The receiver R1 is fixed located during the time period receiving the satellite signals used for calculation of the positioning which is based on trilateration algorithm.

A first satellite signal may be received from a first satellite at a first moment T1 comprising a first distance information d1.

A second satellite signal may be received at a second moment T2 comprising a second distance information d2. This second measurement may happen at a significant different moment at the same satellite so that the difference between d1 and d2 are sufficient for using it like a second measurement results from a different satellite. But in another case the second measurement signal may happen at a different satellite. It may happen that the first satellite is no more visible at a moment T2.

A second satellite signal may be received at a second moment T3 comprising a second distance information d3. Similar to already described scenario at the moment d2, this third measurement may happen at a significant different moment at the same or at a different satellite and the difference between d3 and d1 or d2 are sufficient for using it like a third measurement results from a different satellite in legacy procedure.

FIG. 2 shows a flow diagram of the present invention, wherein the signals of the satellite are received at different moments.

FIG. 2 illustrates the signaling between the receiver R1 and the satellite S1 and S2. The receiver R1 may be a GPS receiver and may receive the satellite signal M1 from the satellite S1 at a moment T1. There may no further satellite visible at that moment. The receiver R1 may receive the satellite signal M2 at the moment T2. The signal M2 may be received from the same satellite when satellite S1 is positioned at a significant different location in order to this second signal M2 is suitable to be used for a 3D trilateration calculation together with the information of the signal m1. The receiver R1 may receive the satellite signal M3 at the moment T3. The signal m3 may be received from the satellite S2. S2 may not be visible when the receiver R1 received the satellite signal m1. The information of the signal M3 may be used for the said 3D trilateration calculation.

In-house studies of high-sensitivity GPS receivers in order to provide the synchronization reference to indoor base stations shows that legacy GPS positioning device sensitivity is about −136 dBm. Single satellite visibility is enough for the synchronization reference, and about 20 dB sensitivity improvement is achievable leading to significantly improved indoor coverage. The key advantage from this invention is that single satellite especially in connection with high sensitivity GPS receiver would be able to provide position information also for in-house applications.

1. Method for calculation of the positioning of an apparatus or an user from satellite signals comprising of the said calculation using the results of at least a first satellite signal and a second satellite signal the said first satellite signal received from a first satellite, and the said second satellite signal not received simultaneously with the said first satellite signal.

2. A method according to claim 1, wherein the receiver of the satellite signals is in fixed location during the time period between the said first satellite signal and said second satellite signal.

3. A method according to claim 1, wherein the said second satellite signal is received from the same said first satellite after it has moved into a different position.

4. A method according to claim 1, wherein the said second satellite signal is received from a second satellite being not visible for the said receiver at the moment receiving the first satellite signal from the said first satellite.

5. A method according to claim 1, wherein the said receiver is a GPS receiver, and the said calculation of the positioning is based on a trilateration algorithm.

6. A method according to claim 1, wherein the said receiver is integrated at a femtocell node.

7. A method according to claim 1, wherein the said trilateration is a 3D trilateration.

8. A method according to claim 1, wherein almanac data comprising of ephemeris data and GPS clock information, are acquired via the internet.

9. A method according to claim 1, wherein almanac data comprising of ephemeris data and GPS clock information, are acquired from the satellites.

10. Apparatus having means adapted for calculation the positioning from satellite signals comprising of arranged for the said calculation by using the results of at least a first satellite signal and a second satellite signal, arranged for receiving the said first satellite signal from a first satellite, and arranged for receiving a second satellite signal not received simultaneously with the said first satellite signal.

11. An apparatus according to claim 10 wherein the said second satellite signal is received from the same said first satellite being different positioned.

12. An apparatus according to claim 10, wherein the said second satellite signal is received from a second satellite being not visible for the said receiver at the moment receiving the said first satellite signal from the said first satellite.

13. An apparatus according to claim 10, wherein the said apparatus is fixed located during the time period between receiving the said first satellite signal and the said second satellite signal.

14. An apparatus according to claim 10, wherein the apparatus is a GPS receiver.

15. An apparatus according to claim 10, wherein the apparatus is part of a base station.

16. An apparatus according to claim 10, wherein the apparatus is part of a femtocell node.
